(19) United States
(12) Patent Application Publication
(10) Pub. No.: US 2025/0352419 A1
(43) Pub. Date: Nov. 20, 2025

(54) IMPROVED TILTING INVERSION EXERCISER FOR INDEPENDENT MOVEMENT OF A USER TORSO

(71) Applicant: Gary Wing, Gainesville, FL (US)

(72) Inventor: Gary Wing, Gainesville, FL (US)

(21) Appl. No.: 19/283,228

(22) Filed: Jul. 28, 2025

Related U.S. Application Data
(63) Continuation-in-part of application No. 17/458,343, filed on Aug. 26, 2021, now Pat. No. 12,370,115.
(63) Continuation-in-part of application No. 17/458,367, filed on Aug. 26, 2021, now Pat. No. 12,390,388.
(60) Provisional application No. 63/070,371, filed on Aug. 26, 2020.
(60) Provisional application No. 63/070,371, filed on Aug. 26, 2020.

(51) Int. Cl. A61H 1/02

(52) U.S. Cl. CPC A61H 1/0229; A61H 2201/0165; A61H 2201/0192; A61H 2201/1609; A61H 2201/1623; A61H 2201/1628; A61H 2201/164; A61H 2203/0493

(57) ABSTRACT

The present invention includes a tilting inversion exerciser that includes a plastic user supporting table having a carrier frame rotatably attached to a foldable base support for allowing a user and a user supporting table to be rotated and inverted relative to the base support. More specifically, this invention relates to a typical tilting inversion exerciser having an adjustable ankle alignment system to make linear adjustments of ankle center of a user relative to hip center of a user. Further, the present invention allows for the torso section of the supporting table to slide independently of the pelvic section of the supporting table and for the torso of a user to be supported in an inclined posture by means of an inclined foam wedge.

### CROSS-REFERENCE TO RELATED APPLICATIONS

This application is a continuation in part of, and claims the benefit of priority to, U.S. application Ser. No. 17/458,343, filed on Aug. 26, 2021, to be patented as U.S. Pat. No. 12,370,115 on Jul. 29, 2025, which claims priority to U.S. Provisional Application No. 63/070,371 having a filing date of Aug. 26, 2020, the disclosure of which is hereby incorporated by reference in its entirety and all commonly owned.

### FIELD OF INVENTION

The present invention provides for an improved tilting inversion table. More particularly, the present invention provides for supporting tables for tilting inversion tables which allow for independent movement of a user's torso separate from a user's pelvic section.

### BACKGROUND

Tilting inversion exercisers are very common tools used to assist users in relief of spinal tensions and pain. Various embodiments of tilting inversion exercisers have been developed and include, at least, a user table rotatably or pivotally attached to a base support, and rotatable relative to the base support. This setup allows for tilting or inversion of a user and attempts to utilize gravity to assist in decompressing and applying traction to the spine.

However, present tiling inversion exercisers have the disadvantage of causing excessive extension of the body during inversion which extends or arches the lumbar spine excessively. The excessive extension forces created by typical tilting inversion exercisers limit traction, prohibit a user from achieving a neutral spine position during inversion and cause unwanted rotational pressures.

One disadvantage of typical tilting inversion exercisers that facilitates excessive extension of the lumbar spine and prohibits neutral spinal alignment during inversion is the inability of the torso section of the supporting table to slide independently of the fixed pelvic section of the supporting table. On typical tilting inversion exercisers, the supporting tables are securely fastened to the frame or carrier. For example, U.S. Pat. No. 5,551,937A discloses a typical tilting inversion exerciser with the supporting table securely fastened to the frame or carrier.

As a user inverts on a typical tilting inversion exerciser, leverage pressure on the pelvis against the supporting table increases as extension forces excessively extend the spine and limit traction. Typical tilting inversion exercisers have no means of producing a dynamic flexion moment to counter the strong extension forces common to typical tilting inversion exercisers and allow for neutral spinal alignment during inversion.

Thus, there remains an unmet need for a tilting inversion exerciser which allows the torso section of the supporting table to slide independently of the fixed pelvic section of the supporting table to mitigate excessive extension forces common to tilting inversion exercisers, facilitating traction and allowing the user to achieve neutral spinal alignment during inversion.

U.S. Publication No. 2013/0059705A1 discloses a supporting table that has been divided into a “primary plate” to support the pelvis and an “auxiliary” plate to support the torso. However, these plates are securely fixed to the frame or carrier of the supporting table and do not allow independent motion of the torso section of the supporting table on the frame or carrier. In addition, Wang does not disclose any intention for separating the supporting table into individual plates.

Thus, there remains an unmet need for a torso section of a supporting table to slide independently of the secured pelvic section of the supporting table to mitigate excessive extension forces common to typical tilting inversion exercisers.

U.S. Pat. No. 4,867,143A discloses a “reclining board running on wheels.” This typical tilting inversion exerciser mounts the supporting table on the frame or carrier on wheels for unrestricted longitudinal translation of the supporting table. However, the reclining board or supporting table is not separated into a pelvic section and torso section. Furthermore, allowing the entire supporting table to slide as a unit places greater pull on the feet and ankles with minimal effect on spinal alignment or traction. As disclosed in the present invention, the torso section of the supporting table must slide independently of the secured pelvic section of the supporting table to mitigate extension forces common to typical tilting inversion exercisers and to maximize traction during inversion.

Various other typical tilting inversion exercisers have disclosed components to increase or enhance the decompression or traction effects of gravity during inversion. For example, U.S. Publication. No. 2015/0305962A1 and U.S. Publication. No. 2016/0228320A1discloses corset or belt type devices which attach to the pelvis of a user and the foot restraint device. However, corsets or belts are not able to effectively facilitate neutral spinal alignment and do not facilitate sliding of the torso section of the supporting table independent of a fixed pelvic section.

U.S. mechanism by which a user can U.S. Pat. No. 5,718,660A to Chen discloses a mechanism by which a user can leverage two handles to move or slide the entire supporting table to increase traction. However, the leverage handles move the entire supporting table and present the aforementioned disadvantage of allowing the entire supporting table to slide as a unit.

Thus, there remains an unmet need for the torso section of the supporting table to move or slide independently of the secured pelvic section to maximize the effects of gravity during inversion and to facilitate neutral spinal alignment.

Another disadvantage of typical tilting inversion exercisers that facilitates excessive extension of the spine and pressure on the feet and ankles is ankle malalignment. Ankle center is behind hip center on all typical tilting inversion exercisers because the back pads of the foot restraint device on all typical tilting inversion exercisers are attached to a metal rod which is securely attached to the longitudinal height adjustment extension. By attaching the back pads of the foot restraint device to the longitudinal height adjustment extension, the ankle center of a user on typical tilting inversion exercisers is positioned well behind the hip center of a user. During inversion, this posterior malalignment of the ankle of a user relative to the hip of a user on typical tilting inversion exercisers creates a rotational lever that increases pressure on the feet and ankles and causes excessive extension, or arching, of the lumbar spine and inhibition of traction. Accordingly, there remains an unmet need to provide for an inversion table that allows for proper ankle alignment

U.S. Pat. Nos. 8,062,198B2 and 7,063,652B1 discloses typical tilting inversion exercisers that attach the back pads of the ankle restraint device securely to the longitudinal height adjustment extension. There is no typical tilting inversion exerciser on which the back pads are not securely attached to the longitudinal height adjustment extension. However, the back pads of the foot restraint device cannot be securely attached to the longitudinal height adjustment extension if the ankle of a user is to be aligned with the hip of a user.

Another disadvantage of typical tilting inversion exercisers is that the isolated movement of the front pads of the foot restraint device against the back pads of the foot restraint device does not facilitate alignment of the ankle of a user with the hip of a user. For example, U.S. Publication No. 2017/0119612A1 and U.S. Pat No. 7,810,773B1 disclose the typical movement of the front pads of the foot restraint device toward the fixed, immovable back pads of the foot restraint device, which are securely attached to the longitudinal height adjustment extension.

However, isolated linear or rotary movement of the front pads of the foot restraint device toward the fixed back pads of the foot restraint device restraint device does not facilitate alignment of the ankle of a user with the hip of a user. Thus, there remains an unmet need for a tilting inversion table which allows for the complete foot ankle restraint device, including the back pads, to be able to move or adjust in a linear direction relative to a user and the supporting table to align the center of the ankle of a user with the hip of user.

A further disadvantage of typical tilting inversion exercisers that facilitates excessive extension of the lumbar spine and prohibits neutral spinal alignment during inversion is failure to support the torso in an inclined angle on the supporting table.

Various tilting inversion exercisers have supported the lumbar spine with cushioned pads and plastic devices. For example, U.S. Publication No. 2013/0059705A1discloses an adjustable plastic component that fits into various slots on the supporting table for the purpose of making contact with or “massaging” the lumbar spine. However, supporting the lumbar spine with a cushioned pad or plastic device may facilitate excessive extension of the lumbar spine and inhibit achieving neutral lumbar spinal alignment. In addition, lumbar pads or supports do not incline the torso of a user.

Thus, there remains an unmet need to allow the torso of a user to be supported in an inclined posture to mitigate extension forces common to typical tilting inversion exercisers.

In addition, there exists an unmet need to address the above-stated problems to mitigate and/or obviate the aforementioned disadvantages of the typical or conventional tilting inversion exercisers.

### SUMMARY OF INVENTION

The present invention includes a tilting inversion exerciser that allows for the torso section of a supporting table to slide independently of the secured pelvic section of the supporting table to mitigate excessive extension forces common to typical tilting inversion exercisers.

The present invention further provides for the torso section of the supporting table to move or slide independently of the secured pelvic section to maximize the effects of gravity during inversion and to facilitate neutral spinal alignment.

In addition, the present invention provides for the torso of a user to be supported in an inclined posture to mitigate extension forces common to typical tilting inversion exercisers. More specifically, this invention relates to a typical tilting inversion exerciser having an adjustable ankle alignment system to make linear adjustments of ankle center of a user relative to hip center of a user.

### BRIEF DESCRIPTION OF THE DRAWINGS

Examples illustrative of embodiments of the disclosure are described below with reference to figures attached hereto. In the figures, identical structures, elements or parts that appear in more than one figure are generally labeled with the same numeral in all the figures in which they appear. Dimensions of components and features shown in the figures are generally chosen for convenience and clarity of presentation and are not necessarily shown to scale. Many of the figures presented are in the form of schematic illustrations and, as such, certain elements may be drawn as simplified or not-to-scale, for illustrative clarity. The figures are not intended to be production drawings. The figures (Figs.) are listed below.

FIG. 1 illustrates at least one embodiment of an inventive 1000 tilting inversion exerciser with a 100 supporting table having at least one 110 torso section/torso sled to slide independently of the at least one 120 fixed pelvic section that allows for independent movement of the torso section/torso sled of the table from the pelvic section of the supporting table, and further illustrating the 210 height adjustment beam, one embodiment of the foot restraint device all supported on a 500 rotatable frame.

FIG. 2 illustrates the posterior view of at least one embodiment of an inventive 100 supporting table that allows the at least one 110 torso section/torso sled to slide independently of the at least one 120 fixed pelvic section of the 100 supporting table, and further illustrating one or more embodiments which include a 121 support beam for fixation to one or more height adjustment bam (not illustrated), one or more 111 excursion region, one or more 112 excursion limiter, one or more 113 slide mechanism, and one or more 114 mechanical stops.

FIG. 3 illustrates at least one embodiment of an inventive 100 supporting table and portion of 210 height adjustment beam, which includes at least one independent sliding 110 torso section/torso sled, at least one 120 fixed pelvic section with an inventive 400 torso wedge attached to the 110 torso section/torso sled.

FIG. 4 illustrates an assembly view of at least one embodiment of an inventive 100 supporting table that allows for independent movement of the 110 torso section/torso sled of the supporting table in relation to the fixed 120 pelvic section utilizing at least one 115 slide plate, at least one 116 posterior plate, and one or more 117 fasteners for connecting the at least one 116 posterior plate to the through the 110 torso section/torso sled of the supporting table.

FIG. 5. illustrates an assembled view of at least one embodiment of an inventive 100 supporting table utilizing at least one 115 slide plate fastened to at least one 116 posterior plate (not shown) through the 110 torso section/torso sled of the supporting table by one or more 117 fasteners (not shown), and further illustrating use of an inventive 400 torso wedge.

FIG. 6 illustrates an assembly view of at least one embodiment of the 200 adjustable ankle alignment system which includes at least one 210 height adjustment beam, at least one 250 vertical foot restraint device having one or more 220 projections, at least one 230 adjustment beam offset strut having one or more holes for receiving said one or more projections of said at least one vertical foot restraint device, and one or more 240 tightening mechanisms for securing said one or more projections of said at least one vertical foot restraint device to said at least one 230 adjustment beam offset strut.

FIG. 7 illustrates an assembly view of at least one embodiment of the 200 adjustable ankle alignment system which includes at least one 210 height adjustment beam, at least one 250 vertical foot restraint device having one or more 221 threaded projections, and one or more 241 tightening mechanisms for securing said one or more projections of said at least one vertical foot restraint device to said at least one 230 adjustment beam offset strut, and at least one 231 ankle alignment spacer.

FIG. 8. provides an assembly view of at least one embodiment of the 200 adjustable ankle alignment system which includes at least one 210 height adjustment beam having at least one 224 spring plate slots and at least one 225 absorption hinge strut, at least one 226 hinge pin, and at least one 250 vertical foot restraint device having at least one 222 absorption spring and at least one 223 absorption spring plate.

FIG. 9 illustrates at least one embodiment of an inventive 1000 tilting inversion exerciser with a 100 supporting table having at least one 110 torso section/torso sled to slide independently of the at least one 120 fixed pelvic section that allows for independent movement of the 110 torso section/torso sled of the 100 table from the 120 pelvic section of the 100 supporting table through the use of a 113 sliding mechanism, all supported on a 500 rotatable frame.

FIG. 10 illustrates the posterior view of at least one embodiment of an inventive 100 supporting table that allows the at least one 110 torso section/torso sled to slide independently of the at least one 120 fixed pelvic section of the 100 supporting table, and further illustrating one or more embodiments which include a 121 support beam for fixation to one or more height adjustment bam (not illustrated), and one or more 113 slide mechanism.

FIG. 11 illustrates an assembly view of at least one embodiment of an inventive 100 supporting table that allows for independent movement of the 110 torso section/torso sled of the supporting table in relation to the fixed 120 pelvic section utilizing at least one 115 slide plate, at least one 116 posterior plate, and one or more 113 slide mechanism which includes one or more 111 excursion region, one or more 112 excursion limiter, and further illustrating a 121 support beam.

FIG. 12 illustrates a perspective assembly view of at least one embodiment of an inventive 100 supporting table that allows for independent movement of the 110 torso section/torso sled of the 100 supporting table in relation to the fixed 120 pelvic section, with the 110 torso section/torso sled utilizing at least one 115 slide plate, at least one 116 posterior plate, and one or more 113 slide mechanism which includes one or more 111 excursion region, one or more 112 excursion limiter, and further illustrating a 121 support beam.

FIG. 13 illustrates at least one embodiment of an inventive 1000 tilting inversion exerciser with a 100 supporting table having at least one 110 torso section/torso sled to slide independently of the at least one 120 fixed pelvic section, with the 110 torso section/torso sled utilizing at least one 115 slide plate, that allows for independent movement of the 110 torso section/torso sled of the 100 table from the 120 pelvic section of the 100 supporting table through the use of a 113 sliding mechanism (not shown), all supported on a 500 rotatable frame.

FIG. 14 illustrates a perspective assembly view of at least one embodiment of an inventive 100 supporting table that allows for independent movement of the 110 torso section/torso sled of the 100 supporting table in relation to the fixed 120 pelvic section, with the 110 torso section/torso sled utilizing at least one 115 slide plate, at least one 116 posterior plate, and one or more 113 slide mechanism which includes one or more 111 excursion region, one or more 112 excursion limiter, and further illustrating a 121 support beam.

FIG. 15 illustrates a perspective assembly view of at least one embodiment of an inventive 100 supporting table that allows for independent movement of the 110 torso section/torso sled of the 100 supporting table in relation to the fixed 120 pelvic section, with the 110 torso section/torso sled utilizing at least one 115 slide plate, at least one 116 posterior plate, and one or more 113 slide mechanism which includes one or more 111 excursion region, one or more 112 excursion limiter, and further illustrating a 121 support beam.

FIG. 16 illustrates a perspective assembly view of at least one embodiment of an inventive 100 supporting table that allows for independent movement of the 110 torso section/torso sled of the 100 supporting table in relation to the fixed 120 pelvic section, with the 110 torso section/torso sled utilizing at least one 115 slide plate, at least one 116 posterior plate, and one or more 113 slide mechanism which includes one or more 112 excursion limiter, and further illustrating a 121 support beam.

FIG. 17 illustrates a perspective assembly view of at least one embodiment of an inventive 100 supporting table that allows for independent movement of the 110 torso section/torso sled of the 100 supporting table in relation to the fixed 120 pelvic section, with the 110 torso section/torso sled utilizing at least one 115 slide plate, at least one 116 posterior plate, and one or more 113 slide mechanism which includes a 121 support beam.

FIG. 18 illustrates at least one embodiment of an inventive 1000 tilting inversion exerciser with a 100 supporting table having at least one 110 torso section/torso sled to slide independently of the at least one 120 fixed pelvic section, with the 110 torso section/torso sled utilizing at least one 115 slide plate, that allows for independent movement of the 110 torso section/torso sled of the 100 table from the 120 pelvic section of the 100 supporting table through the use of a 113 sliding mechanism (not shown), all supported on a 500 rotatable frame.

FIG. 19 illustrates an overhead view of at least one embodiment of an inventive 100 supporting table having at least one 110 torso section/torso sled to slide independently of the at least one 120 fixed pelvic section.

FIG. 20 illustrates an underside view of at least one embodiment of an inventive 100 supporting table having at least one 110 torso section/torso sled to slide independently of the at least one 120 fixed pelvic section (not illustrated) utilizing one or more 113 slide mechanism, and further including one or more electromagnetic switch for releasing the at least one 120 fixed pelvic section when a user is ready to have the 110 torso section move independently of the fixed 120 pelvic section (not illustrated).

FIG. 21 illustrates a perspective assembly view of at least one embodiment of an inventive 100 supporting table having at least one 110 torso section/torso sled to slide independently of the at least one 120 fixed pelvic section using at least one 113 slide mechanism.

FIGS. 22A-22K illustrates various embodiments of the at least one 113 slide mechanism to be utilized in at least one embodiment of an inventive 100 supporting table having at least one 110 torso section/torso sled to slide independently of the at least one 120 fixed pelvic section.

FIG. 22A illustrates a 110 torso section mounted on a 113 slide mechanism comprising of a wheeled slide mechanism. The torso section rides on wheels guided by parallel track rails, with 114 mechanical stops positioned at the distal ends of the track, and one or more 112 excursion limiters disposed within the rail structure to define an adjustable range of motion.

FIG. 22 depicts the 110 torso section mounted via a 113 slide mechanism comprising of a T-shaped slider housed within a T-track. The T-slider engages internally with the track profile, and 114 mechanical stops are located at the terminal ends of the track. An adjustable 112 excursion limiter is included within the track body to define the excursion range of the 110 torso section.

FIG. 22C shows a 110 torso section configured with a 113 slide mechanism comprising of a slotted fastener track. A fixed-position stop or block is inserted into the slot to serve as the 112 excursion limiter, while 114 mechanical stops reside at each end of the slot to cap the movement range. This embodiment may be adapted for retrofit use.

FIG. 22D illustrates a 110 torso section configured with a 113 slide mechanism comprising of a pair of linear rails via a collar or sleeve sled. One or more 112 excursion limiters may be clamped or pinned to the rail, while 114 mechanical stops are fixed near the rail ends to constrain total movement.

FIG. 22E depicts a 110 torso section guided by a 113 slide mechanism comprising of a telescopic rail assembly. Each telescoping segment includes detents or pin stops that define the 112 excursion limiter positions. Fully extended positions are bounded by 114 mechanical stops integrated within the telescoping rail housing.

FIG. 22F shows a 110 torso section configured with a 113 slide mechanism comprising of a magnetically damped slide assembly. A magnetic drag component provides resistive force during translation. A slidable 112 excursion limiter is made from a magnetic stop which limits forward excursion, while hard 114 mechanical stops are integrated at terminal ends of the support structure.

FIG. 22G illustrates a 110 torso section guided by a 113 slide mechanism that is sensor-equipped. One or more 112 excursion limiters are programmable (e.g., digital or mechanical stops) and define user-specific travel ranges. Hard 114 mechanical stops are provided at both ends of the motion path for safety redundancy.

FIG. 22H shows a 110 torso section configured with a 113 slide mechanism comprising of a ratcheting rail that permits unidirectional motion. Manual reset is required to return to the initial position. The maximum ratchet extension is governed by an adjustable 112 excursion limiter, and 114 mechanical stops limit total sled travel.

FIG. 22I depicts a 110 torso section mounted on a 113 slide mechanism comprising of a spring-biased slider. The spring provides resistance during elongation and assists in return. The 112 excursion limiter defines maximum stretch, while the 114 mechanical stops cap movement at both ends of the track.

FIG. 22J illustrates a 110 torso section coupled to a 113 slide mechanism that is a curved slide track that permits arcuate translation. The 112 excursion limiter is positioned along the arc to limit maximum reach, and 114 mechanical stops reside at the terminal arc limits to prevent over-travel.

FIG. 22K depicts a 110 torso section integrated with a 113 slide mechanism that is wedge-mounted tilting slide. The wedge enables both translational and angular displacement. The 112 excursion limiter controls the sliding range, while 114 mechanical stops bracket the sled at both forward and rearward extremes.

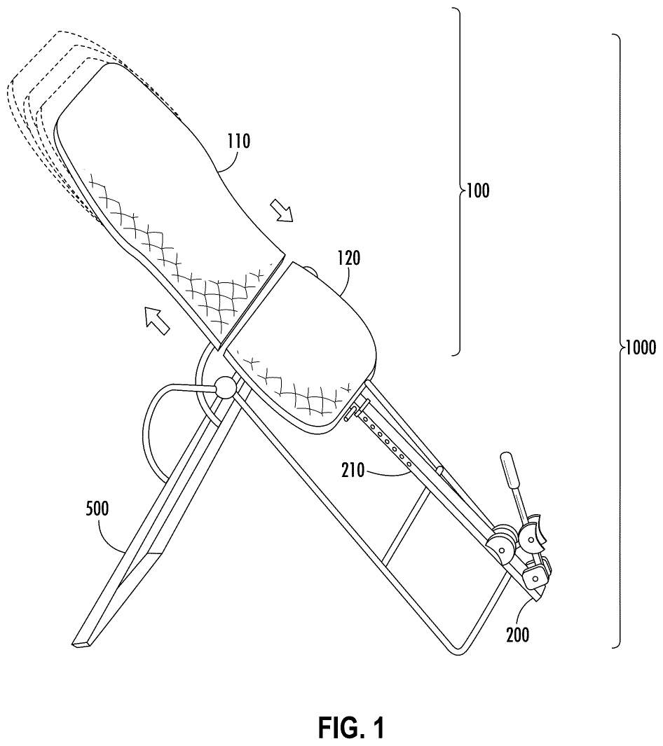

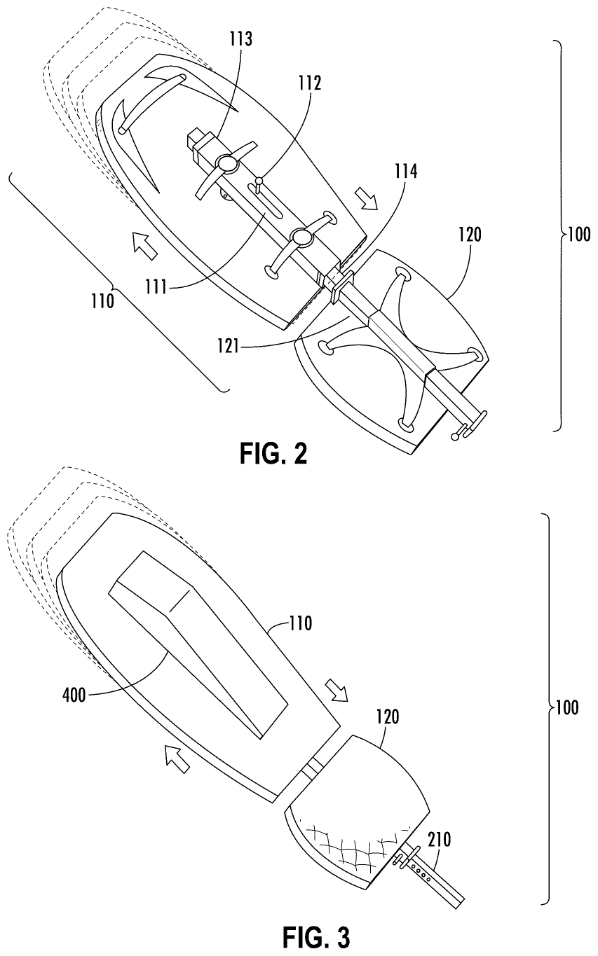

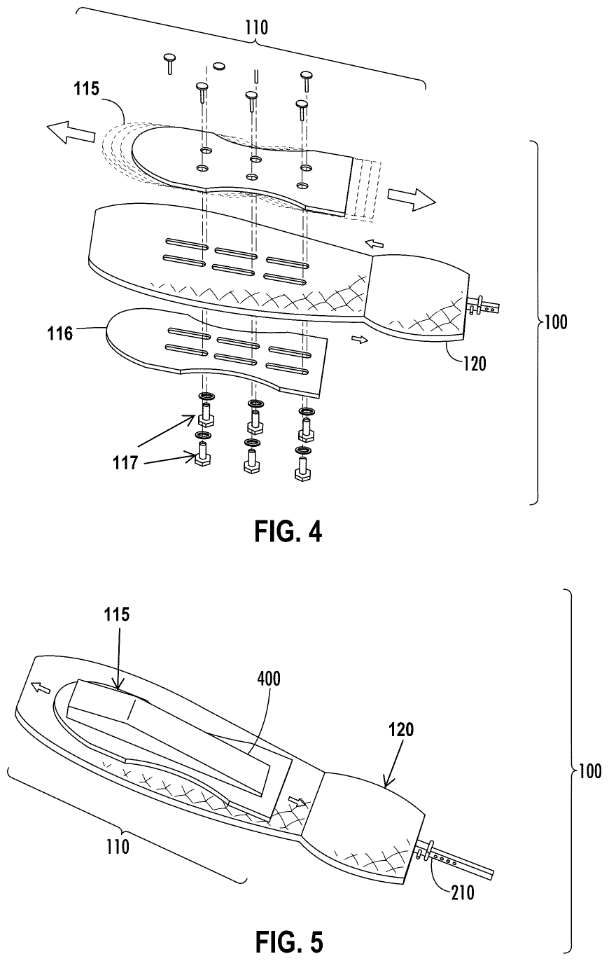

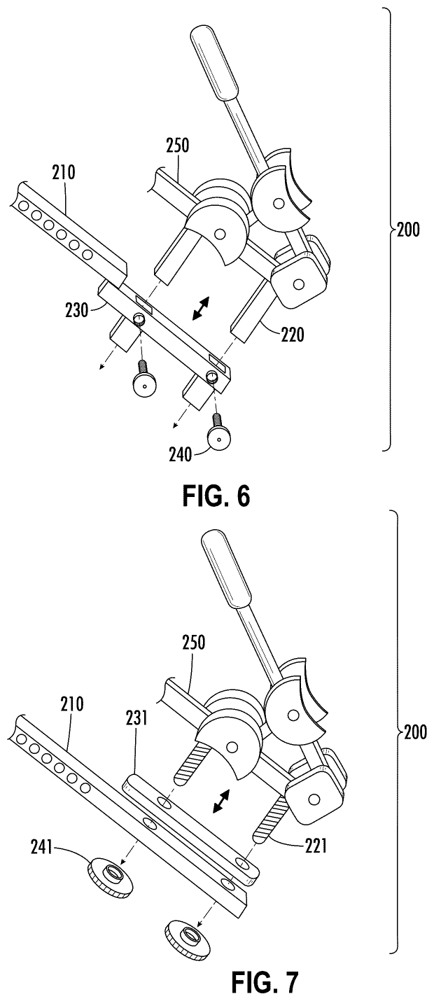

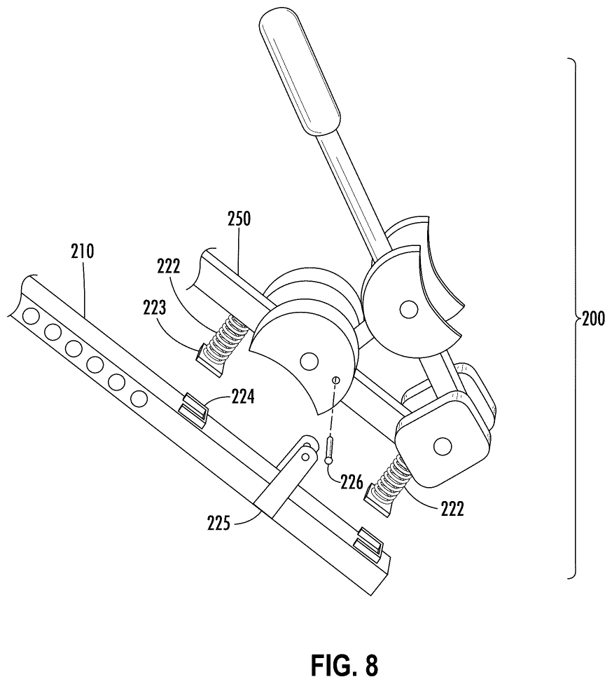

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above-described embodiments that would still be covered by the present invention.

### DETAILED DESCRIPTION

The present invention mitigates and/or obviates the disadvantages of typical tilting inversion exercisers by properly aligning the ankles of a user with the hip of a user, allowing the torso of a user to slide independently of the pelvis of a user and allowing a user to user to assume an inclined posture. The present invention effectively mitigates and/or obviates the excessive extension forces common to typical tilting inversion exercisers, and allows a user to achieve a neutral spinal alignment with increased traction and greatly reduced rotational pressures.

As disclosed in the present invention, the torso section/torso sled of the supporting table must slide independently of the fixed pelvic section of the supporting table to mitigate excessive extension forces common to tilting inversion exercisers and facilitate traction.

As disclosed in this invention, on a tilting inversion exerciser the torso section/torso sled of the supporting table must move or slide independently of the secured pelvic section to maximize the effects of gravity during inversion and to facilitate neutral spinal alignment.

As disclosed in the present invention, the complete foot ankle restraint device, including the back pads, must be able to move or adjust in a linear direction relative to a user and the supporting table to align the center of the ankle of a user with the hip of user.

As disclosed in the present invention, the torso of a user must be supported in an inclined posture to mitigate extension forces common to typical tilting inversion exercisers.

Furthermore, as disclosed in the present invention, the torso section/torso sled of the supporting table must slide independently of the secured pelvic section of the supporting table to mitigate excessive extension forces common to typical tilting inversion exercisers.

The following detailed description is exemplary in nature and is in no way intended to limit the scope of the invention, its application, or uses, which may vary. The invention is described with relation to the non-limiting definitions and terminology included herein. These definitions and terminology are not designed to function as a limitation on the scope or practice of the invention, but are presented for illustrative and descriptive purposes only.

### Sliding Torso Section Torso Sled

One aspect of the present invention is to provide for support tables which allow the torso section/torso sled of the supporting table and torso of a user to slide longitudinally independent of the fixed pelvic section of the supporting table and pelvis of a user.

The primary means to produce a dynamic flexion moment on a tilting inversion exerciser to maximize traction and allow for neutral spinal alignment during inversion is to facilitate the torso of a user sliding independently of the fixed pelvis of a user on the supporting table.

In at least one embodiment, the inventive tilting inversion exerciser has a 110 sliding torso section/torso sled of the 100 supporting table. In at least one embodiment an inventive 110 independent sliding torso section, or torso sled, of the 100 supporting table includes at least one 113 slide mechanism which enables movement of the 110 torso section relative to the 120 pelvic section. In some embodiments, the 113 slide mechanism may further include one or more low friction liner or sleeve. In at least one embodiment, the 113 slide mechanism includes one or more 114 mechanical stops. In some embodiments, the 114 mechanical stops are located at the extremes of the 113 slide mechanism. In at least one embodiment, the 113 one or more slide mechanism further includes one or more 112 excursion limiter, allowing for user adjustment/limitation of the movement of the 110 independent sliding torso section, or torso sled, with respect to the 120 pelvic section, and within the range defined by said one or more 114 mechanical stops. In some embodiments, the 112 excursion limiter operates by limiting motion within a fixed 111 excursion region. In some embodiments, the 112 excursion limiter is adjustable to any point along the one or more 113 slide mechanism.

Embodiment of the invention the torso sled provides a means to facilitate sliding of the torso section/torso sled of the supporting table independent of the fixed pelvic section of the supporting table and pelvis of a user. Without being bound to a particular theory, it is believed that the independent sliding of the torso of a user allows a more neutral spine to be achieved during inversion than on typical tilting inversion exercisers. It is further believed that the independent sliding of the torso of a user on the supporting table also mitigates pressure on the pelvis during inversion common to tilting inversion exercisers and facilitates earlier and greater traction than is common to typical tilting inversion exercisers.

It should be appreciated that in certain embodiments the torso sled extends as a separate moveable plate from just above the fixed pelvic section plate of the supporting table which is securely fastened to the frame. In such embodiments, as a user begins to invert, longitudinal excursion of the torso sled on the central beam of the frame creates a gentle rotation of the torso to counter the excessive extension forces common to typical tilting inversion exercisers. At the point at which excessive pressure against the pelvis of the user from the supporting table would occur on typical tilting inversion exercisers, it is mitigated by longitudinal linear sliding and excursion of the torso sled on the central beam of the frame. This excursion of the sled facilitates earlier and greater spinal traction and allows the spine of the user to assume a more neutral alignment than is common to typical tilting inversion exercisers. In this embodiment torso sled range of motion is determined by the length of the posterior excursion channel and the position of the excursion limiter on the posterior aspect of the central beam. Torso sled motion can be blocked prior to inversion in this embodiment by engaging one or more sled motion stops.

In at least one embodiment an alternative design to facilitate sliding of the torso sled section plate of the supporting table independent of the secured pelvic section plate of the supporting table is provided. In such embodiments, an inventive sliding torso sled includes at least one posterior metal central beam outrigger, at least one central beam rail or slot, at least one metal posterior torso sled torso plate, at least two posterior torso sled wheels, at least two excursion blocks, and at least one sled locking mechanism. Embodiment of the invention provides a means to facilitate longitudinal sliding of the torso sled, independent of the fixed pelvic section, on wheels attached to the torso sled moving in tracks or slots secured to outriggers extending from the central beam of the frame. Materials in this embodiment used to facilitate motion between the torso sled and central beam outriggers include, but are not limited to bearings, low friction plastic, Teflon, and other low friction materials. In this embodiment the torso section/torso sled is allowed unrestricted longitudinal translational movement within a secure range of motion of the torso sled. Movement of the torso sled can be blocked by tightening locking mechanisms on the carrier frame and/or supporting table prior to inversion.

In another embodiment inventive tilting inversion exercisers having a sliding torso section/torso sled of the supporting table are provided. In at least one embodiment, an inventive sliding support table includes at least one slide plate 115, at least one posterior plate 116, and one or more 117 fasteners for connecting the at least one 116 posterior plate to the at least one 115 slide plate through the 110 torso section/torso sled of the supporting table. In such embodiments, the at least one posterior plate is beneath the at least one torso sled, the at least one slide plate is atop the at least one torso sled, and the one or more fasteners connect the at least one posterior plate to the at least one slide plate through the at least one torso sled. In at least one embodiment, it is intended that the slide plate is capable of moving independently from the other elements of the supporting table.

It should be appreciated that in certain embodiments of the present invention, the at least one slide plate, at least one torso sled or at least one posterior plate have a plurality of holes for receiving one or more fasteners. It should be further appreciated that holes implemented into the individual components may be slotted or elongated to allow the slide plate to move several inches about said one or more fasteners.

In embodiments of the invention the slide plate provides a means to facilitate sliding of the torso of a user independent of the pelvic section of the supporting table and pelvis of a user. Without being bound to a particular theory, it is believed that the independent sliding of the torso of a user allows a more neutral spine to be achieved during inversion than on typical tilting inversion exercisers. It is further believed that the independent sliding of the torso of a user on the supporting table also mitigates pressure on the pelvis common to typical tilting inversion exercisers and facilitates earlier and greater traction than is common to typical tilting inversion exercisers. The assembly of plates of embodiments presented herein, are intended to be attached to at least one supporting table. In at least one embodiment the supporting table is made of plastic or other low friction synthetic material.

In certain embodiments, the slide plate may be connected to a plate, or plates, of plastic or other low friction synthetic material on the back of the supporting table through a series of elongated slots in the supporting table. In certain embodiments, it is intended that the plastic plate, or plates, are secured to the back of the supporting table and have slots which mirror those in the supporting table.

In some embodiments, one or more rigid fasteners are used extend from the top surface of the slide plate and connect through to the back of the supporting table. In at least one embodiment the fasteners are threaded locking mechanisms with low friction washers which allow for surfaces to move freely on the surface of the plastic plate. In embodiments with slotted holes, the one or more fasteners move freely in the slots in the supporting table and back plate, allowing unrestricted longitudinal excursion of the slide plate on the torso section/torso sled of the supporting table.

It should be appreciated that in certain embodiments, the slide plate extends from just above the pelvis of a user to the top of the supporting table. In such embodiments, as a user begins to invert, excursion of the slide plate proximally in the slots creates a gentle rotation of the torso in the direction of flexion to counter the excessive rotation forces in the direction of extension. At the point at which pressure against the pelvis from the supporting table would normally occur on a typical tilting inversion exerciser, it is mitigated by proximal linear excursion of the slide on the supporting table. The slide responds to gravity and rotational pressure. As a user returns to the starting position, gravity will cause the slide plate to return to the original bottom position in the slots in the supporting table. Handles or loops attached to the top of the slide plate allow a user to manually increase traction by pulling the slide plate proximally to increase excursion of the slide plate in the slots. Motion of the slide plate can be blocked by tightening the locking mechanisms on the back of the supporting table prior to inversion.

In at least one embodiment, the slide plate is a sheet of high molecular weight plastic or other low friction plastic or synthetic material that slides on the surface of the torso section/torso sled of the supporting table. However, it should be appreciated that embodiments of the invention, the surface of the slide plate and/or supporting table may incorporate other low friction materials to facilitate linear motion between the slide plate and the supporting table including, but not limited to Teflon, balls, bearings, rotary objects, rails or other low friction materials or objects.

Embodiments of the present invention provide for an independent plate which supports the head and neck of a user. In such embodiments, the independent plate is made of high molecular weight plastic or other low friction plastic or synthetic material, and is connected to the slide plate with fasteners which extend from the bottom surface of the slide plate through elongated slots in the head and neck plate. It is intended that the plate supporting the head and neck of a user is able to move independently of the slide plate and supporting table and slide longitudinally on the surface of the slide plate by excursion of the fasteners in the slots. The head and neck plate facilitates gentle traction of the cervical spine during inversion.

In embodiments where a separate torso section/torso sled is allowed to slide on the carrier frame, independent of a fixed pelvic section, the plate supporting the head and neck of a user is attached directly to the supporting table with fasteners through elongated slots in the supporting table. In such embodiments, the plate is able to slide independently on the surface of the torso section/torso sled of the supporting table by excursion of the fasteners in the slots in the torso section/torso sled of the supporting table.

### Ankle Alignment System

One aspect of the present invention is to mitigate/obviate posterior ankle center malalignment common in typical tilting inversion exercisers which facilitates excessive extension of the body during inversion. Embodiments of the invention solves the problem of ankle malalignment with an adjustable ankle alignment system that allows the complete foot restraint device to be incrementally adjusted linearly and perpendicular relative to a user and the supporting table to align the center of the ankle of a user with the center of the hip of a user.

In at least one embodiment an adjustable ankle alignment system for a tilting inversion exerciser is provided which allows for linear adjustments of ankle center of a user relative to hip center of a user. Such embodiments include at least one height adjustment beam, at least one adjustment beam offset strut having one or more holes for receiving one or more struts of a vertical foot restraint strut, at least one vertical restraint strut having one or more projections, and at least one foot restraint device. In such embodiments, the height adjustment beam is connected to one end of the adjustment beam offset strut and the one or more vertical foot restraint strut projections are inserted into one or more holes of said adjustment beam offset strut. The foot restraint device is connected to said at least one vertical foot restraint strut. It should be appreciated that one or more tightening mechanisms for fastening the vertical foot restraint strut projections to the adjustment beam offset strut. In at least one embodiment the vertical foot restraint strut is threaded, while in other embodiments the vertical restraint strut is unthreaded.

Embodiments of the invention, the complete foot restraint device is secured to the vertical foot restraint strut, and moves linear and perpendicular to the longitudinal height adjustment beam and supporting table. In at least one embodiment, welded projections (or projection) from the vertical foot restraint strut slide through openings (or opening) in the adjustment beam offset strut which is welded parallel to the posterior aspect of the shortened longitudinal height adjustment beam. In such embodiments, channels welded to the extension offset strut receive the projections from the vertical foot restraint strut. In such embodiments, pressure tightening mechanisms secure the projections from the vertical foot restraint strut in the channels of the adjustment beam offset strut. When the vertical foot restraint strut is tightened flush against the adjustment beam offset strut, the position of the complete foot restraint device relative to the supporting table mimics the typical tilting inversion exerciser. From this initial flush position, the vertical restraint strut, which secures the foot restraint device, can be slid or adjusted incrementally in a linear direction relative to the supporting table to align the center of the ankle of a user with the hip of a user. It should be appreciated that the projections from the vertical foot restraint strut may be incrementally moved in and out of the openings in the offset strut utilizing, but not limited to, a ratchet mechanism on the projections from the vertical restraint strut common to a drill press or other machinery. Furthermore, it should be appreciated that the adjustment knobs or handles used to engage the ratchet mechanism on the projections from the vertical restraint strut are incorporated into the adjustment beam offset strut. Brackets attached to the offset strut may be substituted for openings in the offset strut to receive projections from the vertical foot restraint strut in certain embodiments

At least one embodiment of the present invention provides springs and hinge to obviate/mitigate ankle center malalignment and absorb changing rotational forces during inversion to reduce pressure on the ankles of the user. In at least one embodiment, at least two springs each with welded plates on either end are attached to opposing ends of the vertical foot restraint strut. In such embodiment, the springs on opposing ends of the vertical foot restraint strut are attached to the offset strut or main height adjustment beam via the plates on the end of each spring sliding into corresponding spring retaining slots on the offset strut or main height adjustment beam. Hinge struts with pivot holes proceeding from the offset strut are secured to the foot restraint strut with a hinge pin. This inventive hinge and spring embodiment improves ankle alignment and adapts to the varying rotational pressures during inversion, reducing foot and ankle pressure common with typical inversion exercisers.

Embodiments of the present invention, the back pads of the foot restraint device are no longer secured or confined to the longitudinal height adjustment beam, as is the case on all typical tilting inversion exercisers. The capability to slide the complete foot restraint device linearly relative to the supporting table in the present invention ensures that the center of the ankle of a user can be aligned with the hip of the user regardless of the size of the user.

Without being bound to a particular theory, it is believed that proper ankle-hip alignment during inversion allows traction forces to be centered through the joints of a user. Thus, it is further believed that proper alignment minimizes rotational pressure on the feet and ankles during inversion and decreases stress on the knees. Thus, the proper ankle-hip alignment facilitates traction and reduces excessive extension forces that excessively extend or arch the lumbar spine. Accordingly, it is further believed that incremental linear movements of the foot restraint device, and therefore ankle center, have a significant impact on flexion-extension forces at the lumbar spine. The capability to influence spinal alignment by incremental linear movements of the foot restraint device is a significant contribution of the present invention to tilting inversion exerciser therapy.

In at least one embodiment, the adjustable ankle alignment allows the projections of the vertical foot restraint strut, which secures the entire foot restraint device, to slide directly through openings in the longitudinal height adjustment beam, omitting the offset extension strut. In such embodiments, the aforementioned ratchet system may be utilized, or any other means to facilitate incremental linear movement of the projections of the vertical foot restraint strut through the openings in the longitudinal height adjustment beam to align the center of the ankle of a user with the center of the hip of a user.

Some embodiments of the present invention provide a static adjustable ankle alignment adjustable ankle alignment design to mitigate/obviate posterior ankle center malalignment common to typical tilting inversion exercisers. In such embodiments, the projections from the vertical foot restraint strut, which secures the complete foot restraint device, slide directly through openings in the longitudinal height adjustment beam, omitting the offset extension strut. In such embodiments, the projections from the vertical foot restraint strut include threaded ends which extend through the openings in the longitudinal height adjustment beam, allowing the vertical restraint strut to rest flush against the longitudinal height adjustment beam, positioning the foot restraint device slightly anterior relative to the supporting table. In at least one embodiment, additional spacers can be added, as needed, between the vertical foot restraint strut and the longitudinal height adjustment beam in order to position the foot restraint device more anterior relative to the supporting table and user in order to achieve the desired ankle center of a user relative to the hip center of a user. In at least one embodiment, locking mechanisms on the posterior side of the longitudinal height adjustment beam engage the threaded projections from the vertical restraint strut and are tightened to secure the foot restraint device once the desired ankle position is achieved.

### Slide Mechanism

Embodiments of the invention include one or more slide mechanism integrated with the at least one torso sled. Such slide mechanism incorporates the mechanics allowing for the movement of the torso sled, while some embodiments of the slide mechanism include one or more excursion limiter to define the range of movement of said at least one torso sled away from said at least one fixed pelvic section and one or more mechanical stop at the extremes.

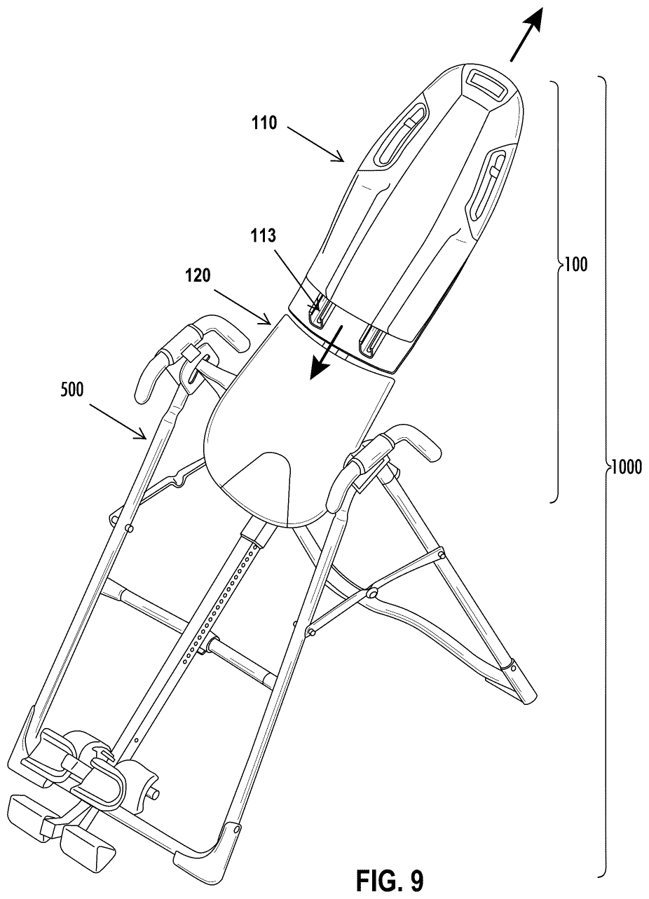

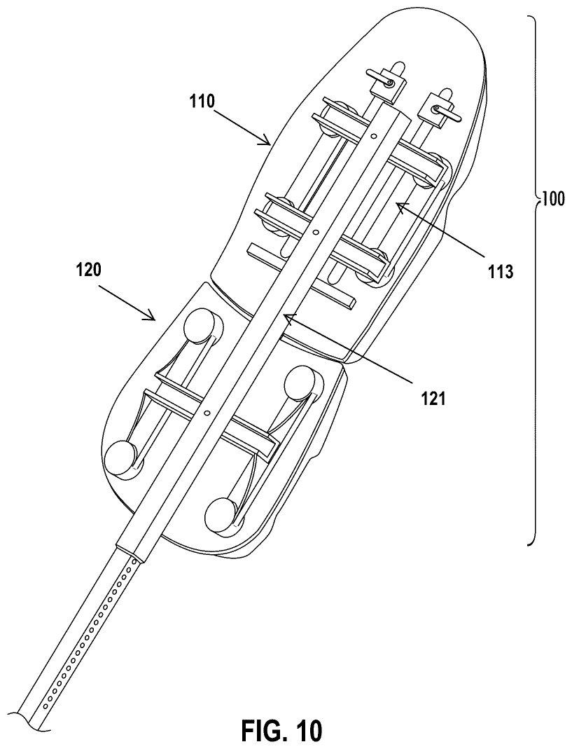

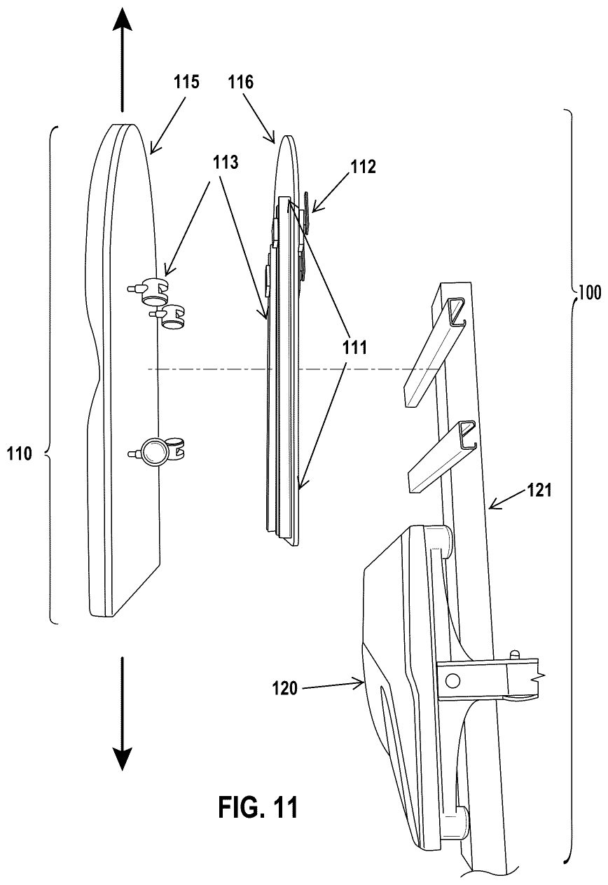

In some embodiments, the 113 slide mechanism includes one or more wheels affixed to a 115 slide plate, wherein the wheels are configured to engage with a track structure formed on the posterior portion of the 110 torso section. The track is contoured to guide the wheel path along a defined longitudinal axis, allowing linear translation of the torso section relative to the fixed pelvic section 120. One or more 114 mechanical stops are integrated at each terminal end of the track to prevent overtravel and provide physical constraints at excursion limits. In this configuration, the wheels may be aligned in parallel or staggered rows to maintain weight distribution and stability under load. A 112 adjustable excursion limiter is included within the track assembly, allowing a user or clinician to set a predefined maximum travel distance of the torso sled. The excursion limiter may be realized as a movable detent, pin, or magnetic brake that interfaces with a stop notch or detent cavity formed along the track. The track may alternatively be formed on the slide plate with the wheels on the posterior structure, enabling a reversed but functionally equivalent configuration. The sliding interface is optimized for low-friction operation under axial spinal load, providing smooth, guided displacement while supporting controlled decompression forces during inversion. Examples of such embodiments are illustrated in FIGS. 9, 10, 11, and 12.

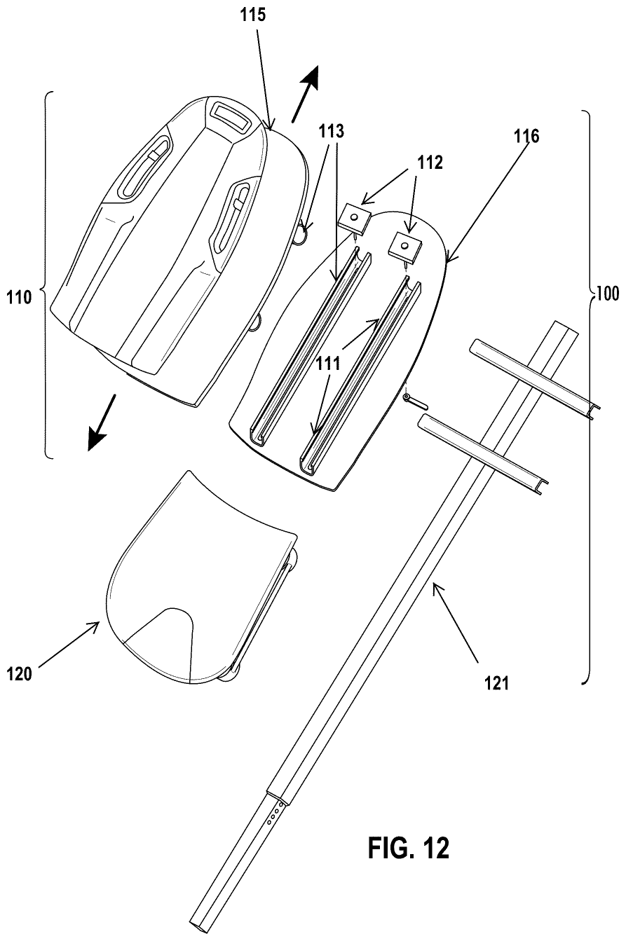

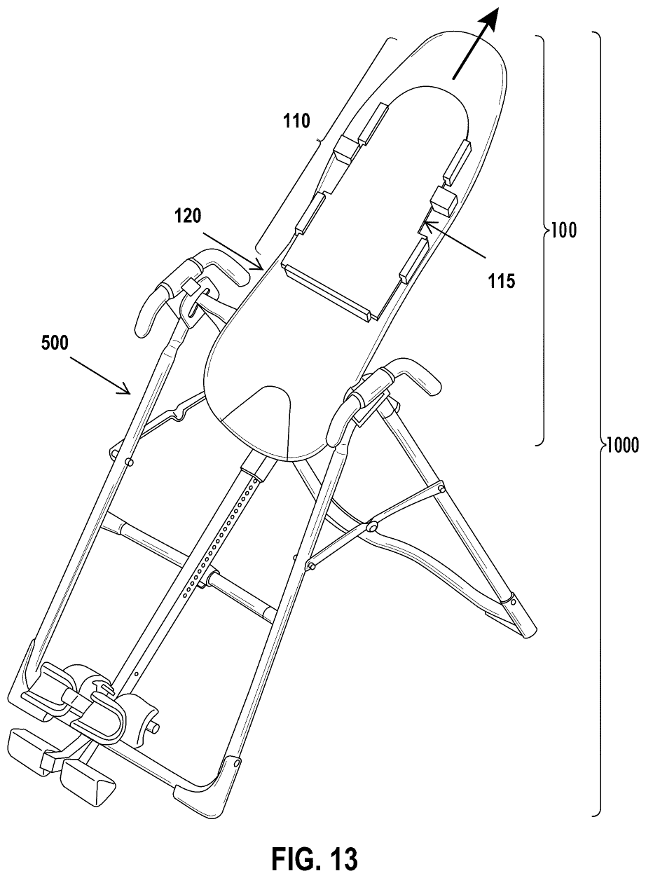

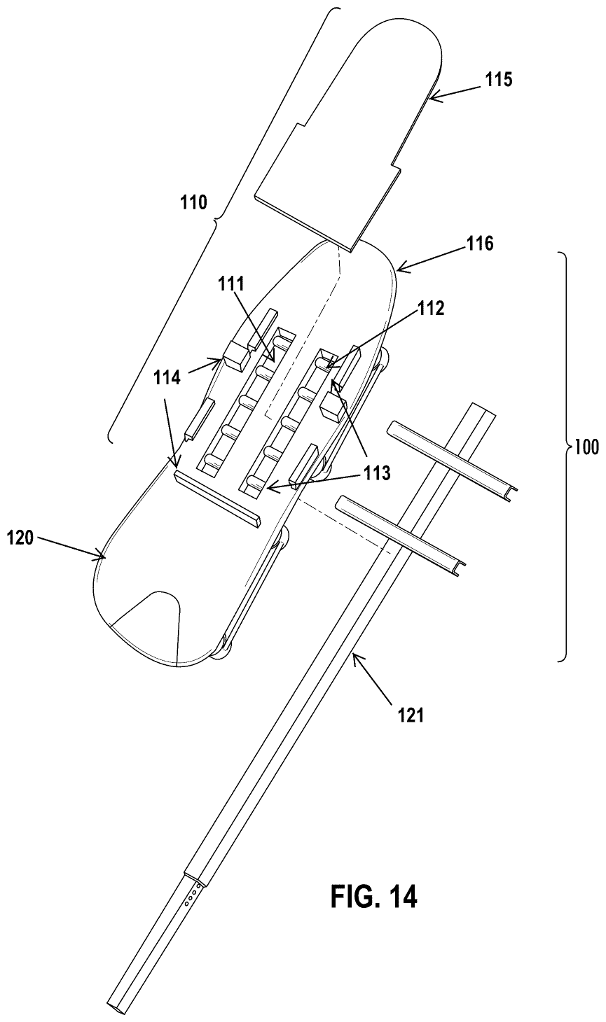

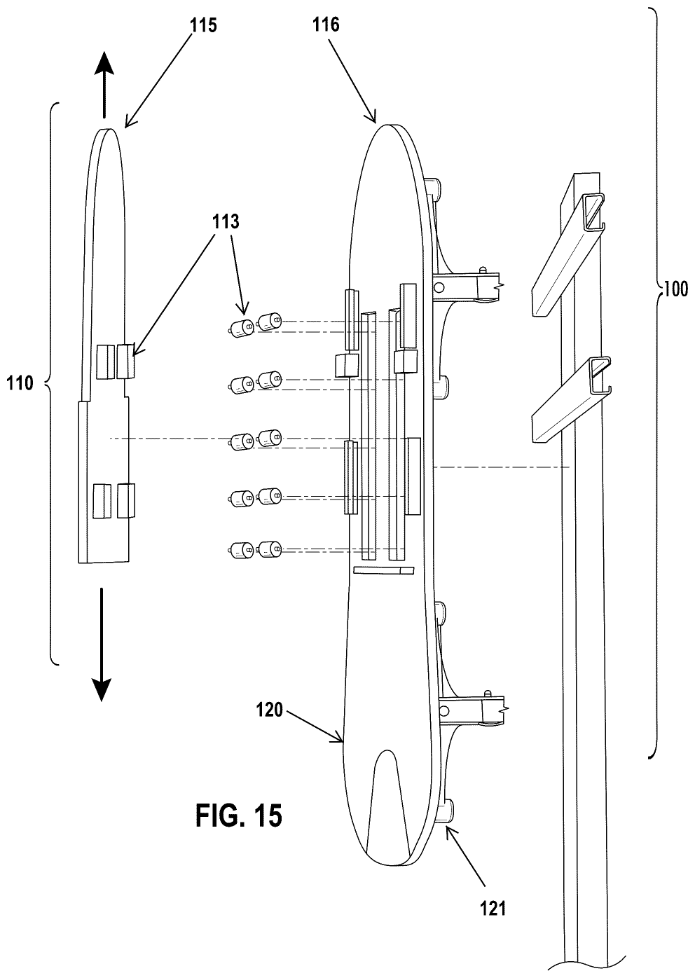

In another embodiment, the 113 slide mechanism is configured using a system of cylindrical rollers inserted into one or more wheel guides formed within either the 115 slide plate or the 116 posterior plate. In one configuration, the slide plate rests atop the posterior plate, with the rollers embedded into the posterior plate to allow smooth rolling displacement of the torso section. A guide rail structure is included to ensure the slide plate remains properly seated and aligned with the posterior plate throughout the motion range. This rail may include lips or recessed channels that nest around the guide ridge of the mating structure. One or more 112 excursion limiters may be placed within the roller channels to define a maximum range of motion. Alternatively, the excursion limiter may be formed as a physical block or pin on the slide plate itself, engaging a detent or receptacle on the posterior surface. 114 Mechanical stops are integrated at the travel limits to provide hard constraints and ensure structural safety. This roller-based configuration provides a robust and weight-bearing translation mechanism well suited for inversion use, and offers potential for modular upgrade or retrofit to existing supporting table designs. Examples of such embodiments are illustrated in FIGS. 13, 14, and 15.

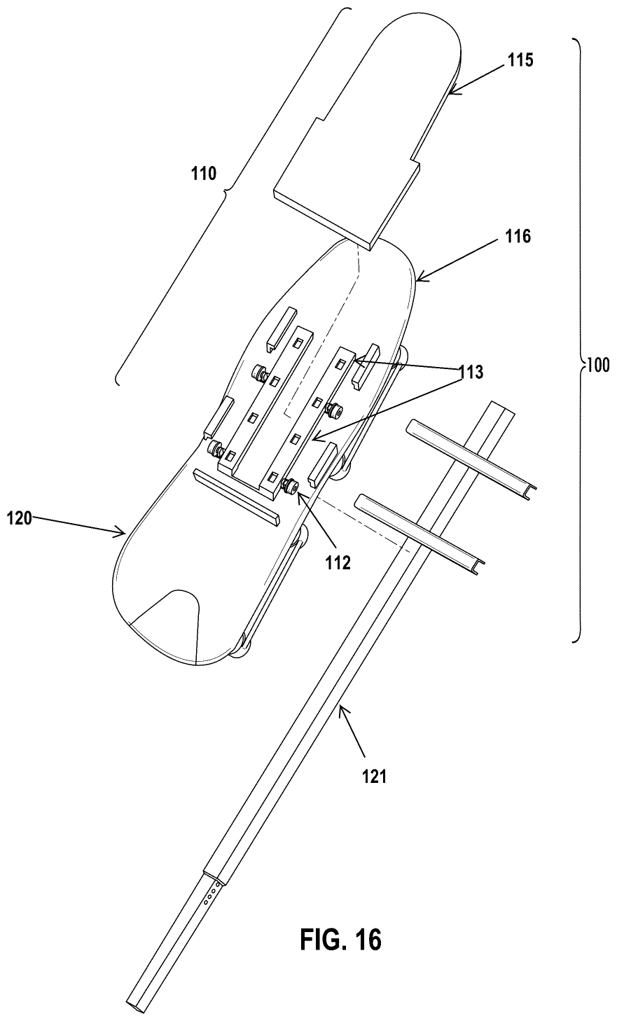

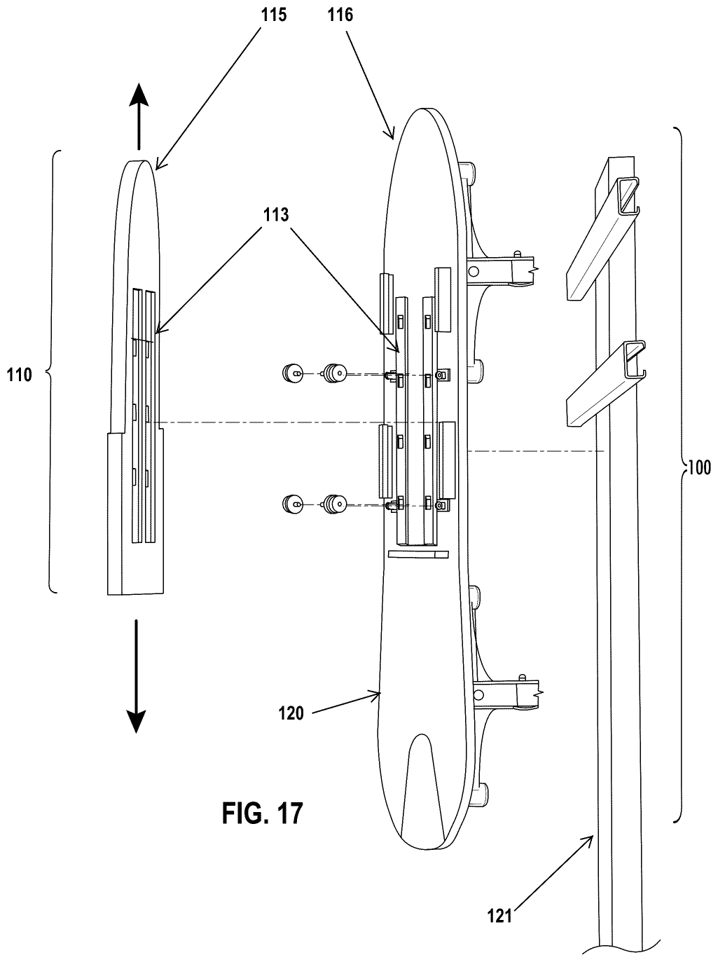

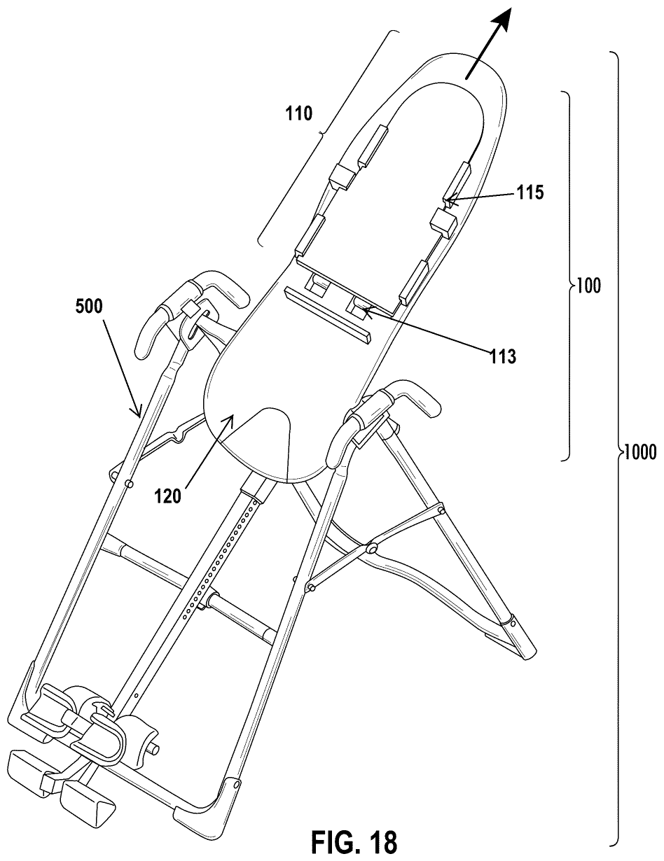

In an alternative embodiment, the roller configuration is inverted from that in FIGS. 13-15. Here, the 113 slide mechanism includes one or more roller channels formed directly into the 115 slide plate, while the rollers themselves are affixed to or housed within the 116 posterior plate. During operation, the slide plate glides over the rollers with its roller channels maintaining alignment and vertical load distribution. This configuration reverses the load-bearing interface without altering the overall functionality. One or more 112 excursion limiters may be located within the roller channels or positioned externally to abut against the edges of the posterior plate to restrict travel. 114 Mechanical stops are positioned at the end of the channels or roller path to prevent disengagement or overextension. The reversed layout may offer improved serviceability or reduced height profile, and may be preferable in applications where posterior components are more rigidly mounted than the torso sled structure. Examples of such embodiments are illustrated in FIGS. 16, 17, and 18.

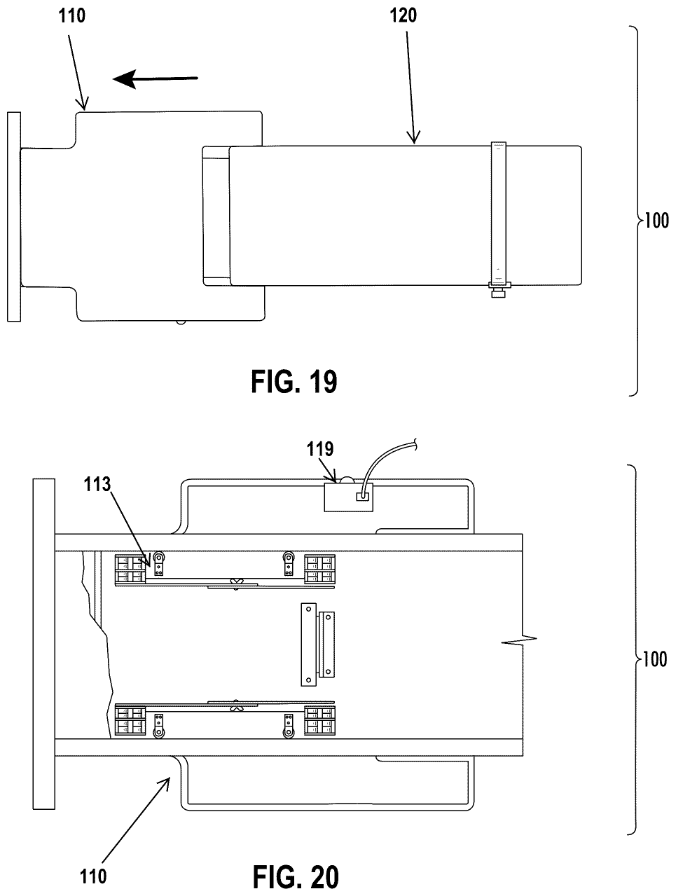

A further embodiment of the 113 slide mechanism involves a modification of the sliding support table. In this embodiment, the supporting table comprises a padded fixed pelvic section and a 110 torso section configured to move longitudinally with respect to the pelvic section. This embodiment integrates a 112 adjustable excursion limiter that defines the maximum displacement range of the torso section. The limiter may comprise a manual pin, magnetic stop, or ratchet mechanism embedded along the support track. Additionally, the configuration is adapted for use in an inversion setting, transforming the horizontal rest table into an inclined or pivoting inversion chair. Structural supports and rotational axes are positioned to allow for full inversion of the system, while maintaining the same sliding mechanism and limiting components. One or more 114 mechanical stops are included to provide fail-safe arrest of motion at end positions, improving the safety and reliability of the inversion configuration compared to the prior art. The system allows controlled spinal traction and decompression through gravity and sled displacement while preserving neutral spinal alignment. Examples of such embodiments are illustrated in FIGS. 19, 20, and 21.

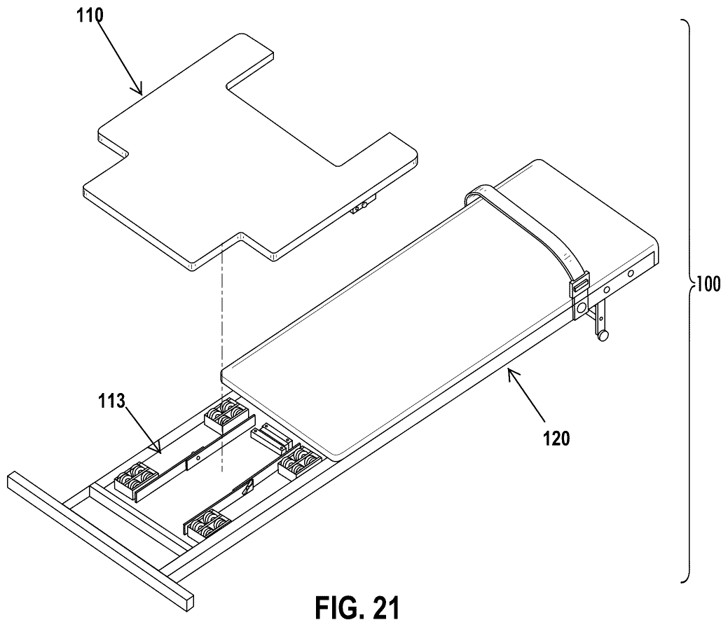

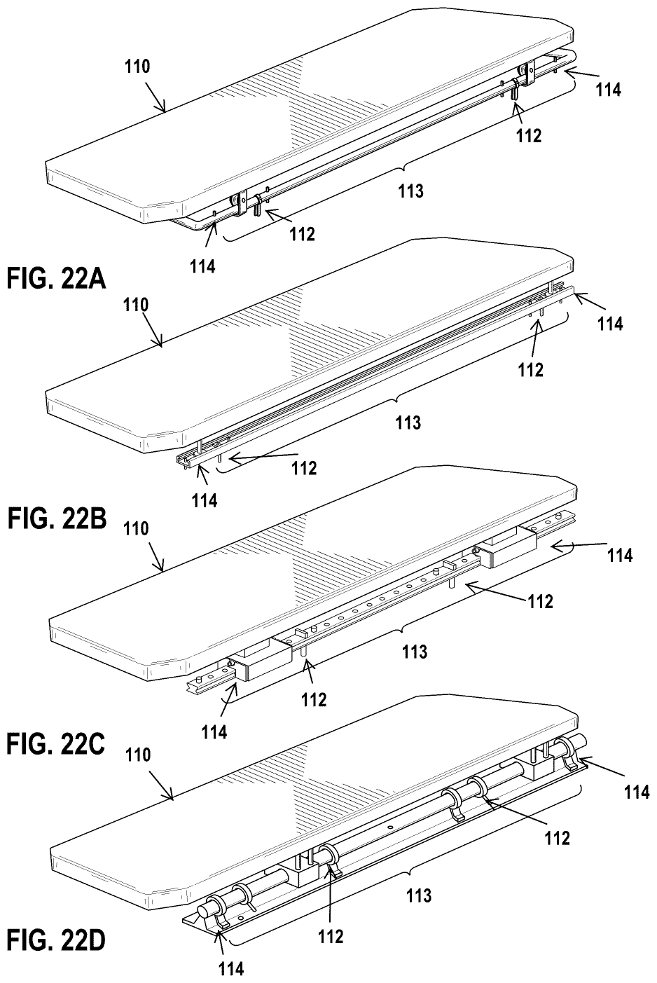

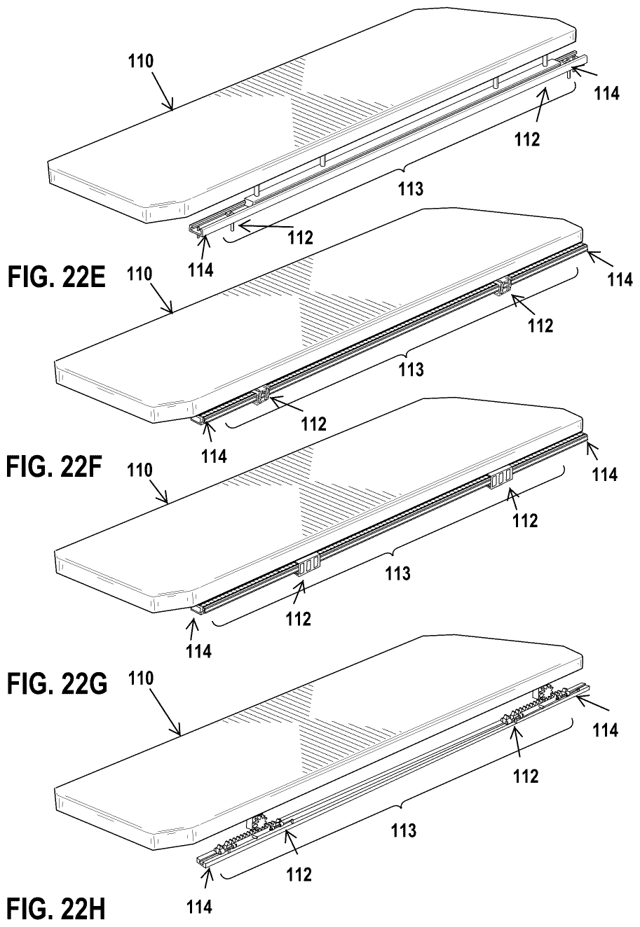

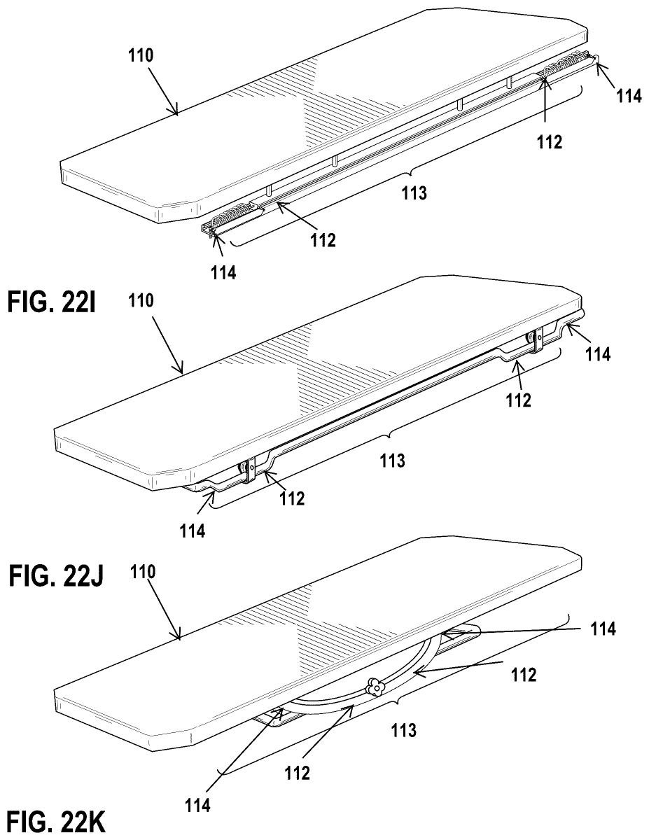

In one embodiment, and as provided in FIG. 22A, the slide mechanism 113 comprises a wheeled rail track assembly supporting the 110 torso section for guided longitudinal motion relative to the 120 fixed pelvic section. The underside of the torso section includes a slide plate or integrated carriage on which a series of load-bearing wheels are mounted via axles or bearing hubs. These wheels are spaced laterally across the width of the sled to distribute weight evenly and maintain alignment. The wheels are configured to run within opposing parallel tracks that extend along the longitudinal axis of the support frame. The tracks are rigidly affixed to the underlying structural members of the inversion table or support beam and may be formed from high-strength extruded metal, machined channels, or reinforced composite rails. A rail guide lip or internal track wall ensures that the wheels remain properly engaged within the rails throughout the entire range of motion.

To restrict displacement and define the operating boundaries of the torso section, 114 mechanical stops are fixed at the terminal ends of the rails. These stops are made from high-impact material or metal plates and are positioned to engage either the front wheel bracket or the slide plate itself, thereby preventing overtravel. Additionally, a 112 adjustable excursion limiter is disposed within each track or along an auxiliary guide bar. The excursion limiter may be realized as a user-adjustable mechanical pin, ratchet stop, or friction block that can be locked into place to define a maximum travel distance. The limiter interfaces with a corresponding abutment on the sled, such as a stop collar or flange, allowing users to tune the range of motion for therapy-specific needs.

This wheeled embodiment minimizes friction during sliding while maintaining precise guided alignment under gravitational load. It is particularly suitable for users requiring smooth motion transitions with minimal shear or lateral deviation. The rail and wheel materials may be selected to reduce noise, vibration, and wear, such as by using polymer-coated wheels and anodized aluminum track surfaces. The design allows for scalable manufacturing and can be implemented in both consumer-grade and clinical-grade inversion tables with modularity in mind.

In another embodiment, and as provided in FIG. 22B, the 113 slide mechanism consists of a T-shaped slider integrated into a recessed T-track affixed beneath the 110 torso section. The T-slider is a monolithic or fabricated extrusion comprising a vertical stem with lateral flanges that interlock within a mating track profile. This geometry provides excellent resistance to lateral displacement and tilt, allowing precise linear translation along the track. The track is mounted to the posterior support structure or frame of the inversion table and extends longitudinally parallel to the spine axis. During use, the slider moves freely within the channel, constrained by the T-profile which prevents lift-off or rotational deviation.

At each end of the track, 114 mechanical stops are installed to restrict further movement of the slider. These stops may take the form of block inserts or bolted end plates secured to the track walls. To permit user-adjustable limitation of travel, a 112 excursion limiter is also integrated into the channel system. The limiter may be implemented as a threaded set screw assembly, magnetic stop block, or sliding detent that can be repositioned along the track and locked into place. The sled or torso structure includes a stop surface or tab that interfaces with the limiter to halt further motion in the defined direction.

This T-slot design is particularly well-suited to applications where structural rigidity and high load capacity are required, due to the large contact area and enclosed engagement between the slider and track. The internal engagement also offers protection from debris and foreign objects, reducing the likelihood of jamming or misalignment. Lubricated or polymer-lined contact surfaces may be used to reduce wear and improve longevity. The track can be machined directly into structural beams or mounted as a separate rail module, providing flexibility in manufacturing and maintenance. Furthermore, this mechanism allows bi-directional motion with robust positional stability, making it ideal for inversion therapies that require controlled torso displacement under dynamic loading conditions.

In another embodiment, and as provided in FIG. 22C, the 113 slide mechanism is implemented as a slotted fastener track integrated into the posterior portion of the 110 torso section or support assembly. The slide plate includes a mating protrusion or channel edge that rides within a longitudinal slot. The slot is typically machined, molded, or extruded into a base plate and allows the torso section to travel forward and backward along the slot axis. A set of one or more fasteners are positioned within the slot and pass through the slide plate, securing the moving portion to the slotted channel while still permitting linear translation. These fasteners may include sliding bolts, shoulder screws, or key-in-groove mechanisms that prevent vertical lift while allowing horizontal displacement.

To control movement boundaries, 114 mechanical stops are embedded at the end of each slot. These stops may be molded bosses, hardened end caps, or metal tabs inserted into the channel to limit motion physically. In addition, a 112 adjustable excursion limiter is positioned within the slot and configured to interfere with the fastener or mating component once the torso section reaches a defined excursion. The limiter can be realized as a repositionable pin, block, or cam-lock device that can be moved along the slot and locked into place using a screw, friction detent, or magnetic retention system. This allows practitioners to set individualized excursion limits based on user comfort, therapy goals, or safety parameters.

This slotted track configuration offers a compact, low-profile mechanism for controlled translation and is particularly suited for retrofitting existing support tables or designing systems where minimal mechanical complexity is desired. It is inherently simple and robust, relying on minimal moving parts and easily replaceable components. The track may be formed from reinforced plastics, aluminum, or steel depending on the application. When used in therapeutic inversion tables, the slotted fastener system provides an effective means of controlling spinal decompression range without sacrificing lateral stability or increasing system height.

In a further embodiment, and as provided in FIG. 22D, the 113 slide mechanism utilizes a pair of linear guide rails on which a collar-style or sleeve-type sled is mounted. The rails are affixed in parallel alignment beneath the 110 torso section and extend longitudinally toward the 120 fixed pelvic section. Each rail is precision machined or extruded to provide a smooth cylindrical or square guide surface, and the sled includes matching bores or channels that slide over the rails. The sled structure is either directly connected to the torso section or integrated into its posterior surface. This configuration allows the torso sled to translate smoothly along the guide rails with minimal play.

One or more 112 excursion limiters are provided in the form of clamped collars or adjustable pins that are fastened to the rails at selected locations. As the sleeve sled travels along the rails, it abuts against the excursion limiters and is prevented from moving further, thereby defining the excursion range. These limiters may be manually repositionable and include locking mechanisms such as threaded set screws or compression latches. To prevent overextension or accidental disengagement, fixed 114 mechanical stops are placed near the ends of each rail. These are typically hardened collars, end caps, or frame-integrated barriers that stop sled motion definitively.

The dual-rail and sleeve system provides high structural stability and low-friction linear motion, particularly under high axial load. Because the sleeve sled wraps around both guide rails, lateral movement and torsional displacement are significantly reduced. This configuration is ideal for heavy-duty applications or clinical-grade inversion tables where motion precision and patient safety are paramount. Materials such as anodized aluminum for the rails and polymer bushings for the sleeves may be used to ensure durability and smooth operation over thousands of cycles.

In a further embodiment, and as provided in FIG. 22E, the slide mechanism 113 includes a telescopic rail assembly that supports the 110 torso section for longitudinal displacement along the inversion axis. The telescoping system comprises nested structural members, with each segment dimensioned to slide within the next, similar to an extendable drawer slide or linear motion arm. The torso section is mounted to the outermost (moving) segment, while the innermost segment is affixed to the structural base or to the 120 pelvic section support. Intermediate sliding segments provide graduated extension, allowing for compact stowage and extended range of motion during operation.

To define the limits of motion, each segment includes a 112 excursion limiter, which may be realized through mechanical detents, spring-loaded pins, or indexed locking notches. These limiters are positioned at predefined intervals to allow selectable travel limits. For example, a ball detent or cam pin may be selectively inserted into holes machined in the intermediate segments to restrict extension at a user-defined point. When maximum extension is reached, each segment sequentially abuts a corresponding 114 mechanical stop, which can be fixed tabs, collars, or molded flanges formed into the rail walls. These stops prevent overtravel and ensure the nested segments do not disengage or bind under load.

The telescoping members are designed to resist bending and lateral deflection, and may incorporate guide bushings or low-friction sliders to maintain alignment during motion. Materials such as anodized aluminum, hardened steel, or reinforced composite can be used depending on the required load capacity and duty cycle. This telescopic mechanism allows for an extended motion profile in a compact form factor, making it well suited for inversion devices where available envelope is limited but full range torso excursion is required. The system also facilitates simplified transport and folding designs without compromising the strength or stability of the sliding structure

In a further embodiment, and as provided in FIG. 22F, the slide mechanism 113 features a magnetically damped translation system supporting the 110 torso section. In this configuration, the torso sled is mounted on a set of low-friction rails or a planar support surface, with one or more magnetic dampers positioned to resist rapid displacement. The magnetic damping elements are typically permanent magnets affixed to the underside of the sled or mounted adjacent to ferromagnetic plates in the support structure. As the torso section slides, eddy currents induced in the metal surfaces generate drag forces that resist sudden movement, creating a smooth and controlled motion profile.

The primary motion path is defined by guide rails or channels integrated into the posterior structure of the inversion table. The sled includes sliding interfaces, either wheels, bushings, or glide pads, which remain in close contact with the track surface. One or more 112 excursion limiters are included in the magnetic damping system, typically realized as movable magnetic stops. These stops may use opposing polarities to create a repelling force at predefined points, thereby establishing a magnetic “wall” at the desired excursion limit. Alternatively, physical stop blocks may be combined with the magnetic damping system to establish hard positional boundaries.

114 Mechanical stops are fixed at the ends of the travel path to arrest motion and protect against overextension. These may include structural bumpers or bolted brackets attached to the track ends. The magnetic damping system is passive, requiring no external power source, and can be tuned by varying magnet strength, distance to the conductive surface, or by altering sled geometry. This mechanism offers the advantage of silent operation, minimal wear, and inherently smooth user experience, especially during inversion when abrupt motion can cause user discomfort or loss of control.

This embodiment is particularly valuable in therapeutic or clinical settings where consistent resistance, smooth deceleration, and repeatable excursion control are prioritized over pure mechanical complexity.

In a further embodiment, and as provided in FIG. 22G, the slide mechanism 113 includes one or more integrated sensors to monitor and control the position of the 110 torso section in real time. The system includes a linear guide rail or sled mechanism, which may use wheels, bushings, or low-friction pads to support and direct the torso section. Alongside the mechanical guide system, one or more position sensors, such as optical encoders, linear potentiometers, magnetic Hall-effect sensors, or laser rangefinders, are mounted to provide continuous feedback on the torso section's displacement.

Excursion limits are defined programmatically or mechanically via 112 excursion limiters, which may be implemented as software-defined thresholds within a control module or as adjustable mechanical stops. In digital implementations, the sensors report sled position to a controller that halts further motion when a predefined limit is reached. This may interface with an electromagnetic brake, clutch, or solenoid stop mechanism that physically restrains further movement. In analog configurations, the sensors may trigger lights, buzzers, or indicators to guide user operation.

114 Mechanical stops are incorporated as fixed end-of-travel barriers to ensure safety in the event of sensor failure or power loss. These stops can be physical plates, bumpers, or spring-loaded absorbers. The smart sensor-equipped mechanism provides high-precision feedback, enabling real-time monitoring of therapy sessions, adjustment of excursion ranges, or integration with biofeedback systems. Optional features may include Bluetooth or wired communication with external devices, allowing for automated logging, clinician adjustment, or integration into rehabilitation protocols.

This embodiment enhances user safety and performance monitoring, and is especially suited for use cases requiring personalized therapy plans, adaptive control, or user-specific excursion profiles. Redundancy and fail-safes are incorporated to ensure that in the event of electronic malfunction, mechanical stops and friction constraints still maintain control over torso section travel.

In a further embodiment, and as provided in FIG. 22H, the slide mechanism 113 includes a ratcheting rail system configured to allow unidirectional displacement of the 110 torso section along the inversion axis. The ratcheting mechanism comprises a toothed track integrated into the support frame and a ratchet pawl mounted on the sled or torso structure. As the user inverts or moves, the pawl engages successive teeth in the ratchet rail, locking the torso section incrementally in its extended position. This mechanism allows the torso section to gradually extend under body weight or muscular control, creating a dynamic traction effect.

To reset the position, the user or operator must manually disengage the pawl using a lever or release button, allowing the sled to return to its starting position. This return may be assisted by gravity, spring bias, or user effort depending on the configuration. A 112 excursion limiter is incorporated into the ratchet track by either terminating the ratchet teeth at a fixed location or using a mechanical block within the tooth profile to prevent further engagement beyond a certain point. The ratchet mechanism itself may be spring-loaded to ensure secure tooth engagement and minimal backlash during loading.

114 Mechanical stops are provided at each end of the track to prevent overtravel and protect the pawl and ratchet from excessive force. These may be fixed plates, housing end walls, or integrated bumpers designed to arrest motion abruptly but safely. The ratcheting slide system is particularly well suited for controlled incremental spinal decompression therapies, where stepwise elongation under load offers therapeutic benefit. The mechanism offers tactile and audible feedback to the user, enhancing the sense of control during use. Materials for the ratchet and pawl components are selected for wear resistance and strength, such as hardened steel or engineered polymers with high impact resistance

In a further embodiment, and as provided in FIG. 22I, the slide mechanism 113 includes a spring-biased configuration that supports and controls the movement of the 110 torso section along the longitudinal axis of the support table. This mechanism employs one or more springs arranged in tension or compression, providing a resistive force that acts against displacement of the torso sled. The springs are anchored between the torso section and the fixed base structure, such that when the user inverts or applies force, the springs elongate (or compress), storing energy. Upon release of load, the springs facilitate a return motion, gently repositioning the sled to its resting position.

The torso section is mounted on a slide plate or carriage that translates over a set of rails, glide pads, or low-friction surfaces. The spring elements may be coil springs, gas springs, or elastomeric bands, depending on the desired response profile. One or more 112 excursion limiters are included to define the allowable range of sled movement. These limiters may be physical pins or blocks that restrict spring elongation beyond a preset length, or may comprise adjustable collars on the spring shaft or a tethered cable with travel stops. The excursion limiter ensures that the torso section moves only within a clinically safe and therapeutically effective distance.

114 Mechanical stops are located at the forward and rearward ends of the travel path, preventing overextension of the sled or overcompression of the spring system. These may include frame-mounted bumpers, terminal bushings, or bracketed stoppers designed to absorb residual force. In some variants, the stops may also engage a lockout mechanism to hold the torso section in a predefined retracted or extended position.

The spring-biased slide mechanism offers a passive and self-regulating motion system, making it ideal for users who may not require or desire complex motorized or electronic components. It is especially well-suited for applications emphasizing gentle decompression, cyclical movement, or user-driven dynamic stretching. The spring resistance can be tuned via interchangeable spring rates, preload settings, or mechanical leverage changes, allowing therapists or users to personalize the resistance curve based on body weight, flexibility, or therapy objectives.

In a further embodiment, and as provided in FIG. 22J, the slide mechanism 113 comprises a curved track designed to guide the 110 torso section along an arcuate path. This configuration enables simultaneous linear and angular displacement of the torso during inversion, supporting spinal decompression with a biomechanically advantageous motion profile. The curved track may be circular, elliptical, or parabolic in geometry, and is affixed to the supporting frame or posterior section of the inversion device. The torso section includes a sled or carriage equipped with rollers, bushings, or sliding pads that interface with the track and follow its curvature during displacement.

The 112 excursion limiter is positioned along the track path to define the maximum permissible movement of the torso section. This limiter may take the form of an adjustable block, a ratcheting pin system, or a locking collar that can be clamped at a desired arc length. The position of the limiter can be customized based on user needs, range-of-motion limits, or prescribed therapy protocols. As the sled travels along the curved guide, it eventually contacts the limiter, which halts further movement and maintains the sled at a fixed arcuate offset.

114 Mechanical stops are located at both terminal ends of the curved track and serve as absolute barriers to prevent the sled from exceeding the designed path. These may be formed as end caps, frame-integrated projections, or shock-absorbing bumpers. The engagement between sled and track is typically enclosed or partially wrapped to prevent lift-off, especially during inversion. In some variants, the system includes torsional support structures to reduce flex or sway during movement.

This arcuate slide system is particularly beneficial for replicating natural spinal motion under load and may provide enhanced engagement of deep spinal musculature. It also offers better weight distribution during torso translation, as compared to linear mechanisms, and can enhance user stability and comfort. The track curvature and arc radius are selected based on anthropometric studies to optimize spinal alignment and decompression angles during inversion.

In a further embodiment, and as provided in FIG. 22K, the slide mechanism 113 comprises a wedge-mounted tilting interface that permits both linear translation and angular tilt of the 110 torso section relative to the supporting table. The wedge assembly includes an inclined plane or platform upon which the torso section is mounted. This wedge is supported on a set of rails, tracks, or sliding elements that allow movement along the longitudinal axis of the inversion device. As the sled translates along the wedge, the torso section simultaneously elevates or depresses relative to the base frame, resulting in a combined translational and angular adjustment.

The 112 excursion limiter is integrated into the wedge system and defines the total displacement along the inclined path. This limiter may be implemented as an adjustable block on the wedge track, a threaded screw stop, or a telescoping bracket that physically restricts sled motion. By adjusting the limiter position, the clinician or user can select the maximum tilt angle and excursion length to suit therapeutic goals or user comfort. The limiter may also be coordinated with wedge height or angle to vary spinal loading characteristics dynamically.

114 Mechanical stops are provided at both extremes of the wedge rail to prevent overtravel and maintain positional safety. These stops may include rubber bumpers, bolted end blocks, or integrated casting features on the wedge housing. The interface between the wedge and sled may include friction-reducing pads or bushings, or in some variants, may incorporate bearing rails to allow for smooth compound motion.

This wedge-mounted slide mechanism provides a hybrid kinematic path that mimics spinal flexion, extension, or decompression depending on the angle and excursion selected. It is particularly useful in advanced therapeutic regimens that require non-linear movement patterns or staged positional changes. The wedge angle may be fixed or adjustable, and can be tailored to user anatomy or therapy objectives. Additionally, the system offers opportunities for synchronized movement, where the wedge slide is coupled to other components of the inversion table, allowing for coordinated multi-axis motion that enhances overall efficacy and comfort.

### Torso Wedge

Embodiments of the invention include restraining devices to positive engage the torso and pelvic section of the supporting table to the torso and pelvis of a user. Examples of suitable restraining devices include bands, straps, friction tape, adhesive, or other friction increasing materials known in the art.

Other aspects of the present invention solve the problem of supporting the torso of a user in an angle of inclination. In at least one embodiment, an inventive dual plane torso wedge is implemented with inventive tilting inversion exercisers in to facilitate maintaining the torso of a user in an angle of inclination during inversion.

Embodiments of the torso wedge provide for an inclined or semi-inclined irregular shaped wedge of foam, rubber or other compressive material that can be attached to the slide plate by a number of projections on the bottom of the wedge which engage slots and/or holes in the slide plate, or independent sliding torso section/torso sled of the supporting table. In at least one embodiment, the torso wedge utilizes Velcro or other attachment materials for engagement with the slide plate, or independent sliding torso section/torso sled of the supporting table. It should be appreciated, that when used, the wedge can be moved as necessary on the slide plate, or independent sliding torso section/torso sled of the supporting table, to adjust to the height of a user.

In at least one embodiment, the torso wedge is narrower than the slide plate and torso sled, approximating the width between the scapula, to facilitate active rotary mobility of the spine during inversion, if desired, as well as to open the chest and position the shoulders in more optimal alignment. In at least one embodiment, the wedge is thicker at the top than the bottom, and beginning at neck level of a user, the torso wedge is approximately parallel to the supporting table and contoured to cradle the neck of a user in order to support the head and neck of a user near neutral alignment.

Certain embodiments of the inventive torso wedge acts as a lever to enhance function of the slide plate. As a user begins to invert, pressure against the torso wedge is transferred to the slide plate, dynamically activating the slide.

In embodiments where the torso sled slides independently on the carrier frame, the torso wedge dynamically activates the torso section/torso sled of the supporting table, rather than the slide plate.

It is believed that the dynamic flexion moment created by the torso of a user positioned on a wedge during inversion creates an effective counterforce to the persistent dynamic extension forces common to typical tilting inversion exercisers which prohibit neutral spinal alignment during inversion. Accordingly, it is believed that embodiments of the torso wedge effectively neutralize the strong extension forces created when a user raises the arms overhead during inversion and mitigates, in conjunction with independent sliding of the torso, excessive ribcage elevation during inversion common to typical tilting inversion exercisers. As a result, there is less compression on the diaphragm during inversion, and the compromised breathing during inversion common to typical tilting inversion exercisers is mitigated. It is further believed that the torso wedge provides proprioceptive feedback to a user. Accordingly, in embodiments where used, the support of the wedge gives a user greater initial sensory feedback during inversion which provides a sense of security for a user and enhances user control of the rate of inversion.

It is believed that use of a torso wedge alone on common tilting inversion exercisers results in an increase in friction and loss of traction during inversion. However, when the torso wedge is used in conjunction with the sliding torso embodiments and adjustable ankle systems, as disclosed herein, it facilitates rather than inhibits traction by acting as a lever to activate the torso sled or slide plate.

### Other Embodiments

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments.

The foregoing description is illustrative of particular embodiments of the invention, but is not meant to be a limitation upon the practice thereof. The following claims, including all equivalents thereof, are intended to define the scope of the invention.

1. A supporting table for a tilting inversion exerciser, the supporting table comprising:
at least one fixed pelvic section; and
at least one torso sled having one or more slide mechanism, wherein said slide mechanism of said at least one torso sled comprises one or more excursion limiter to define the range of movement of said at least one torso sled away from said at least one fixed pelvic section when said supporting table is inverted or partially inverted;
wherein said at least one torso sled moves independent of said at least one fixed pelvic section.

2. The supporting table of claim 1 wherein said supporting table is configured such that when a user positioned on said table inverts said tilting inversion exerciser, said torso sled slides away from said fixed pelvic section a distance based on the range of movement defined by said excursion limiter.

3. The supporting table of claim 1 further comprising at least one torso wedge to be placed between said at least one torso sled and a user of said supporting table, wherein said torso wedge is thicker at the top than the bottom and contoured to cradle the neck of a user in order to support the head and neck of a user.

4. The supporting table of claim 1, wherein said at least one torso sled further comprises one or more sled motion stop to mechanically block motion of said at least one torso sled away from said at least one fixed pelvic section when said supporting table is inverted.

5. The supporting table of claim 1, wherein the slide mechanism comprises one or more of a wheeled rail mechanism, a T-slot slider, a slotted fastener track, a linear rail with a collar or sleeve sled, a telescoping rail assembly, a magnetically damped slide, a sensor-equipped guide mechanism, a ratcheting slide system, a spring-biased slide, a curved track arcuate guide, a wedge-mounted tilting slide, or combinations thereof.

6. A tilting inversion exerciser, comprising:
at least one supporting table for supporting a subject using said tilting inversion exerciser, said supporting table further comprising:
at least one fixed pelvic section; and
at least one torso sled, wherein said at least one torso sled moves independent of said at least one fixed pelvic section;
wherein said at least one torso sled includes a slide mechanism, wherein said slide mechanism of said at least one torso sled further comprises one or more excursion limiter to define the range of movement of said at least one torso sled away from said at least one fixed pelvic section when said supporting table is inverted or partially inverted.

7. The tilting inversion exerciser of claim 6 further comprising at least one ankle alignment system.

8. The tilting inversion exerciser of claim 6, wherein said at least one torso sled further comprises one or more sled motion stop to mechanically block motion of said at least one torso sled away from said at least one fixed pelvic section when said at least one supporting table is inverted.

9. The tilting inversion exerciser of claim 6, wherein said at least one ankle alignment system allows for linear adjustments of a user's ankle center relative to the user's hip center.

10. The tilting inversion exerciser of claim 7, wherein said at least one ankle alignment system further comprises:
at least one height adjustment beam;
at least one vertical foot restraint device having one or more projections;
at least one adjustment beam offset strut having one or more holes for receiving said one or more projections of said at least one vertical foot restraint device; and
one or more tightening mechanism;
wherein said at least one height adjustment beam is connected to one end of said at least one adjustment beam offset strut;
wherein said one or more projections of said at least one vertical foot restraint device are inserted into said one or more holes of said at least one adjustment beam offset strut; and
wherein said at least one vertical foot restraint device is connected to said at least one adjustment beam offset strut by said one or more tightening mechanisms securing said one or more projections of said at least one vertical foot restraint device.

11. The tilting inversion exerciser of claim 10, wherein said one or more projections of said at least one vertical foot restraint device of said ankle alignment system is threaded.

12. The tilting inversion exerciser of claim 6, wherein the slide mechanism comprises one or more of a wheeled rail mechanism, a T-slot slider, a slotted fastener track, a linear rail with a collar or sleeve sled, a telescoping rail assembly, a magnetically damped slide, a sensor-equipped guide mechanism, a ratcheting slide system, a spring-biased slide, a curved track arcuate guide, a wedge-mounted tilting slide, or combinations thereof.

13. A tilting inversion exerciser, comprising:
at least one ankle alignment system;
at least one supporting table for supporting a subject using said tilting inversion exerciser, said supporting table further comprising:
at least one fixed pelvic section; and
at least one torso sled, wherein said at least one torso sled moves independent of said at least one fixed pelvic section;
wherein said ankle alignment system further comprises:
at least one height adjustment beam;
at least one vertical foot restraint device having one or more projections;
at least one adjustment beam offset strut having one or more holes for receiving said one or more projections of said at least one vertical foot restraint device; and
one or more tightening mechanism;
wherein said at least one height adjustment beam is connected to one end of said at least one adjustment beam offset strut;
wherein said one or more projections of said at least one vertical foot restraint device are inserted into said one or more holes of said at least one adjustment beam offset strut; and
wherein said at least one vertical foot restraint device is connected to said at least one adjustment beam offset strut by said one or more tightening mechanisms securing said one or more projections of said at least one vertical foot restraint device.

14. The tilting inversion exerciser of claim 13, wherein said at least one torso sled further comprises one or more excursion limiter to regulate the range of movement of said at least one torso sled away from said at least one fixed pelvic section when said supporting table is inverted or partially inverted.

15. The tilting inversion exerciser of claim 13, further comprising at least one torso wedge to be placed between said at least one torso sled and a user of said supporting table, wherein said torso wedge is thicker at the top than the bottom and contoured to cradle the neck of a user in order to support the head and neck of a user.

16. The tilting inversion exerciser of claim 13, wherein the slide mechanism comprises one or more of a wheeled rail mechanism, a T-slot slider, a slotted fastener track, a linear rail with a collar or sleeve sled, a telescoping rail assembly, a magnetically damped slide, a sensor-equipped guide mechanism, a ratcheting slide system, a spring-biased slide, a curved track arcuate guide, a wedge-mounted tilting slide, or combinations thereof.

17.-24. (canceled)
